(19) United States
(12) Patent Application Publication
(10) Pub. No.: US 2005/0157775 A1
(43) Pub. Date: Jul. 21, 2005

(54) Temperature probe and use thereof

(75) Inventor: Peter A. Chapman, Avon By The Sea, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Maverick Industries, Inc., Edison, NJ (US)

(21) Appl. No.: 10/991,012

(22) Filed: Nov. 17, 2004

Related U.S. Application Data
(60) Provisional application No. 60/520,837, filed on Nov. 17, 2003.

(51) Int. Cl. G01K 1/00

(52) U.S. Cl. 374/170; 374/185; 374/208

(57) ABSTRACT

A temperature probe is provided. The temperature probe preferably includes a tip made from a material having a relatively high thermal conductivity coefficient, an insulating member and metallic tubular member. The insulating member serves as a thermal buffer between the tip and the tubular member.

### CROSS REFERENCE TO RELATED APPLICATIONS

This application claims the benefit of the filing date of U.S. Provisional Patent Application No. 60/520,837 filed Nov. 17, 2003, the disclosure of which is hereby incorporated herein by reference.

### BACKGROUND OF THE INVENTION

The present invention relates to temperature probes and in particular to temperature probes for measuring the internal temperature of food.

Temperature measurement provides useful information in a variety of applications. Internal body temperature, ambient air temperature, internal food temperature, temperature in a vehicle's engine, etc., are but a few examples of the many types of temperature measurements that occur as part of everyday life. Older generation thermometers typically comprised a substantially cylindrical glass tube that housed a column of mercury. The glass tube was marked with numbers to indicate different temperature readings. As the mercury heated up, for example, when the thermometer was placed under a tongue, it slowly rose to indicate the temperature of the subject or item being measured. The mercury-based thermometer was beset by two main problems, speed and accuracy. That is, it took a relatively long period to provide a reading. The rule of thumb for taking body temperatures using these thermometers required that the thermometer remain in place for at least three minutes. When a reading was ready to be taken, aside from the inherent inaccuracy associated with using mercury, determining the exact position of mercury relative to the temperature markings was fraught with error. In particular, the contrast between the mercury and the glass was not sharp enough to enable determination of the level of mercury relative the markings on the glass tube. Indeed, it was often impossible to determine the exact position of the mercury and thus determine the measured temperature. Moreover, mercury ultimately proved to deleterious to the environment, e.g., disposal.

With the advent of digital technology, a new age for thermometers also arrived. Digital thermometers that are able to provide a relatively fast and accurate reading are now available. These digital thermometers rely on different technologies to sense the temperature of the subject or item and different methods for providing a fast reading. For example, thermometers are available that use infrared radiation to sense the temperature being measured and to provide a reading under one minute. Infrared thermometers are, however, limited to specialized environments such as taking the temperature of a subject via an ear. Nonetheless, there is still room for error. In particular, if the infrared beam of light does not enter the ear canal, then the measurement will not be accurate. In addition, these thermometers are not generally suited for certain environments, such as determining the internal temperature of food being cooked.

Another type of popular thermometer includes a probe made of a stainless steel member that includes a tip. A thermistor is disposed within the probe proximate its tip. The thermistor senses the temperature at its tip and provides a signal which is converted to a temperature reading, e.g., to a digital temperature reading by a microprocessor. This type of thermometer, however, is also not able to provide a relatively fast and accurate reading. In particular, stainless steel is a poor heat conductor and most probes are typically six inches long. Thus, when the probe is inserted in food, it takes a relatively long time for the tip of the probe to reach (i.e., heat up) to the internal temperature of the food. In addition, there is usually some heat diffusion between the tip and remainder of the probe. For example, in an application where the tip of the probe is at higher temperature than the rest of the probe, heat usually diffuses from the tip out along the remainder of the probe. On the other hand, where the tip of the probe is at lower temperature relative to the rest of the probe (e.g., in an oven), heat diffuses down the probe to the tip. Accordingly, it takes a relatively long period of time for these types of probes to obtain an accurate temperature reading. Furthermore, during the settling time of these types of probe, i.e., the time it takes the entire structure of the probe to thermally stabilize, the temperature displayed will vary. This often leads to user confusion.

A reduction in the time it takes to obtain an accurate temperature reading is of utility. In particular, shortening the amount of time it takes to obtain an accurate reading reduces the risk of user confusion. Furthermore, the risk that a user will rely on an inaccurate reading is reduced. For example, in the food industry, if a meat is not cooked to its proper internal temperature, there is a risk of food poisoning. The Food and Drug Administration (FDA) in its pamphlet entitled “Thermy: Use A Food Thermometer,” the disclosure of which is incorporated by reference herein, publishes recommendations regarding the proper internal temperatures that various meats must reach in order to avoid food poisoning. Prior art thermometers increase the risk of food poisoning by not providing accurate temperature readings. Thus, where a user is provided with a quick and accurate reading of the internal temperature of a meat, the risk of food poisoning may be reduced.

### SUMMARY OF THE INVENTION

An aspect of the present invention is the provision of a temperature probe wherein the tip of the probe is thermally isolated from the rest of the probe to prevent heat from diffusing between the tip and the remainder of the probe. In accordance with this aspect of the present invention, thermal isolation may be achieved by preferably placing a ceramic buffer between the tip and shaft of the probe. On the other hand, the thermal buffer may include a polymer, such as an epoxy or similar material including, but not limited to, rubber and plastics. Most preferably, the tip of the probe is approximately 1.5 millimeter (mm) in length. In addition, the thermal buffer is of a hollow design which allows the wires that are connected to a thermistor in the tip to be threaded through the probe to a display or a device having such display capability. Alternatively, in accordance with this aspect of the present invention, the thermal buffer may not be of a hollow design.

Further, in accordance with this aspect of the present invention, the tip of the probe is preferably made from a relatively highly conductive material such as silver or copper. By using materials having a relatively high thermal conductivity the true temperature readings may be achieved more quickly thereby desirably reducing the response time of the thermometer.

Another aspect of the present invention is a method for programming a microprocessor used in a thermometer. The method begins by delaying acquisition of a temperature reading so as to allow the tip, most preferably a silver or copper tip, of the probe to actualize with the object whose temperature is being monitored. After approximately one second, the temperature readings are taken approximately every 400 millisecond (ms). Every three readings are compared and the third reading is communicated to a display device, e.g., Liquid Crystal Display (LCD).

In another aspect of the present invention, after a predetermined time delay temperature readings may be taken at various time intervals, for example, approximately every 500 ms. The current temperature readings and the successive measurements are then compared and a new temperature reading is communicated to a display device, such as a Liquid Crystal Device.

In another aspect of the present invention, a combination is provided that comprises a probe having a highly-conductive tip which is coupled to a microprocessor that preferably includes a program that performs a method for calibrating a temperature reading. The method comprises delaying acquisition of a temperature reading so as to allow the tip of the probe to actualize with the food whose temperature is being monitored. After approximately one second, the temperature readings are taken approximately every 400 millisecond (ms). Every three readings are compared and the third reading is communicated to a display device, e.g., Liquid Crystal Display (LCD).

In accordance with this aspect of the present invention, a more accurate temperature probe is provided that is able to provide temperature readouts much faster, e.g., two degrees accuracy within two seconds or three seconds. In general, the relative speed and accuracy of a device using or employing the method as compared to prior art designs will typically depend upon the temperature difference between the thermal probe and the subject to be measured. In addition, by isolating the probe's tip, temperature readings will be quickly and accurately displayed regardless of the temperature of the surrounding environment.

In another aspect, the microprocessor may take a temperature measurement and display a temperature reading in approximately 500 ms. The microprocessor automatically compares the current temperature measurement to previous measurements and may then communicate the result to a display device. Preferably, if the temperature measurement is higher than a predetermined number of degrees, for instance 3° F., the temperature display may be delayed. Once the temperature measurement rises less than a predetermined number of degrees, for example 3° F., the temperature may then be displayed.

In yet another aspect, the present invention is a thermometer comprising an enclosing including an insulating member having first and second ends, a conductive metal tip connected to the insulating member first end and a tubular member connecting to the insulating member second end. The thermometer further preferably includes a thermistor mounted within the enclosure proximate the conductive tip and coupled to a display by a pair of wires that are coupled to the thermistor at opposing end surfaces.

Further in accordance with this aspect, the thermometer further preferably comprises a processor coupled to the pair of wires and to the display. The processor is capable of computing the temperature sensed by the thermistor based on signals communicated by the pair of wires and providing a readout to the display. Most preferably, the readout is in the form of a digitally-encoded signal.

In addition, the thermometer display further preferably comprises a microprocessor that computes a temperature reading based on the signals communicated by the wires and which provides a readout of the computed temperature to the display.

Other aspects include the enclosure being desirably substantially cylindrical in shape. It is further desirable that the insulating member be made from a ceramic material or other non-thermal conducting material such as an epoxy.

Most preferably, the conductive tip has a first end and a second end, and the distance between the first and second ends is less than 2 millimeters. In a further embodiment, the distance between the first and second ends of the conductive tip is at least 1.5 millimeters.

Further in accordance with this aspect of the present invention, the insulating member is a ceramic insulator. Furthermore, the tubular member is desirably made of stainless steel. It may also be desirable to have the metal tip comprise a silver tip or a copper tip.

Another aspect of the present invention is the provision of a temperature sensor. The temperature sensor preferably comprises a probe having a silver or copper tip, a stainless steel tubular portion and a thermal insulating portion. In accordance with this aspect of the present invention, the sensor also includes a thermistor having opposing end surfaces mounted within the probe and coupled to a pair of electrode wires at each of the opposing end surfaces to take out thermistor signals. In accordance with this aspect, the insulating portion is desirably mounted between the silver or copper tip and the stainless steel tubular portion so as to form a thermal buffer between the tip and the tubular portion.

Further in accordance with this aspect of the present invention, the thermistor is mounted proximate the tip. In addition, the stainless steel tubular portion of the temperature sensor desirably includes an opening into which is mounted a basal display for providing a basal temperature readout.

Further in accordance with this aspect of the present invention, the thermal insulating portion is substantially cylindrical in shape and includes an outer surface, a central cylindrical bore and a circular stop member that projects from the outer surface and wherein the tip and stainless steel tubular portions are slidably mounted over opposite ends of the thermal insulating portion so as to each abut the circular stop member.

It may also prove desirable to have the silver tip length be between approximately 1.5 to 2.0 millimeters.

In yet another aspect, the present invention is the provision of a thermometer enclosure comprising a silver or copper tip having a first end and a second end. The thermometer further preferably includes a cylindrically-shaped thermal insulating member having a first end and a second end and a cylindrical bore, the thermal insulating member first end being connected to the first end of the silver tip. The thermometer further desirably includes a metallic tubular portion having a first end and a second end, wherein the second end of the metallic tubular portion is connected to the second end of the thermal insulating member.

Further in accordance with this aspect of the present invention, the distance between the first and second ends of the silver tip is preferably less than or equal to 2 millimeters. It may further prove desirable to have the distance between the first and second ends of the silver tip be at least 1.5 millimeters.

Another aspect of the present invention is the provision of a temperature probe comprising a silver tip, a shaft member, and a ceramic buffer coupled between the silver tip and the shaft members so as to define a substantially cylindrical shape for the temperature probe. In accordance with this aspect of the invention, a thermistor is preferably mounted within the silver tip and electrically coupled to a microprocessor house within the shaft member for calculating a temperature based on signals received from the thermistor.

In accordance with another aspect of the present invention, a computer readable medium is provided for executing computer readable instructions comprising delaying taking a reading for a second after the temperature probe is inserted in a food; repeatedly measuring the temperature of the food every 400 milliseconds; comparing the last three measurements to compute an average temperature; and providing a third temperature reading to a display.

In accordance with another aspect of the present invention, the computer readable medium may take temperature readings at different predetermined time periods, such as every 0.5 seconds.

In accordance with the above aspects of the present invention, an accurate temperature reading may be obtained on thin foods such as hamburgers or chicken cutlets.

### BRIEF DESCRIPTION OF THE DRAWINGS

FIG. 1 is an illustrative exploded view of a temperature probe in accordance with an aspect of the present invention.

FIG. 2 is a perspective view of a thermometer in accordance with an aspect of the present invention.

FIG. 3 is a perspective view of a temperature probe in accordance with an aspect of the present invention.

FIG. 4 is a perspective view of a temperature probe in accordance with an aspect of the present invention.

FIG. 5 illustrates a method in accordance with an aspect of the present invention.

FIG. 6 illustrates an exploded view of a thermometer in accordance with an aspect of the present invention.

### DETAILED DESCRIPTION

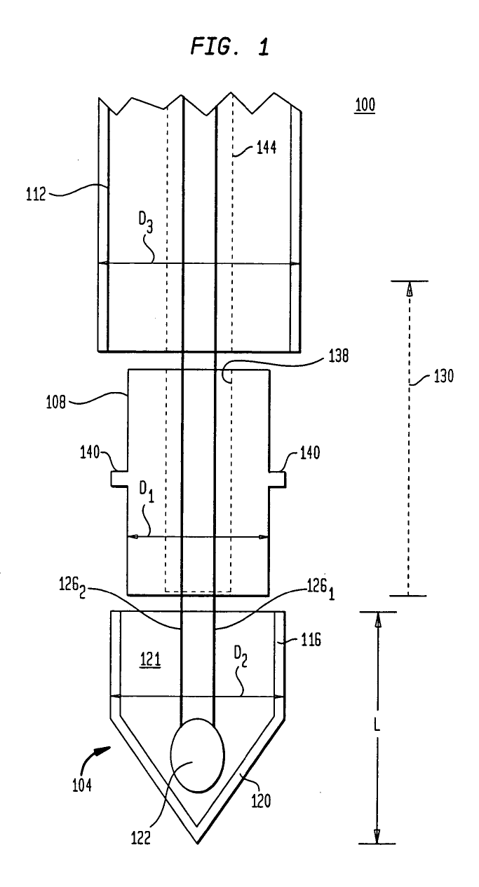

Turning now to FIG. 1, there is depicted an exploded illustrative view of a temperature probe 100 in accordance with an aspect of the present invention. The probe 100 includes a tip 104, a ceramic insulator 108 and a metallic tubular member 112. The tip 104 includes a substantially cylindrical run 116 that terminates on a point 120. A space 121 is formed in the interior of the tip 104 and, as shown, includes a thermistor element 122 that is coupled to a pair of electrode wires 126₁ and 126₂.

The length L of the tip 104 is typically 1.5 millimeter (mm) along the cylindrical axis 130 and may be as long as 2.0 mm. The length of the tip 104 impacts the area available for heat to diffuse in a direction parallel to the cylindrical direction. The tip 104 is preferably made of a conductive metal. Such conductive metals preferably include silver or copper; however, any other highly-conductive metal which is a good conductor may be used. In particular, the thermal conductivity of silver is about 406 W/m K (Watts per meter for each degree Kelvin). Copper's thermal conductivity is approximately 385 W/m K. Although aluminum's thermal conductivity (205 W/m K) is not as high as either copper or silver, it may also be used to construct the tip 104. The thermal conductivity of the materials from which the tip is made determines how quickly the tip of the probe will reach the temperature of its surrounding environment. The thermistor 122 then senses the temperature of the tip 104 and signals from the thermistor are communicated from the thermistor over the wires 126 to display device or a microprocessor that is part of the display or coupled thereto. Output signals 126 contain information relating the resistance (R) and temperature characteristics (T) of the thermistor 122.

As seen in FIG. 1, the wires 126 are threaded through an opening 138 in the ceramic insulator 108. The insulator 108 is cylindrical in shape and includes a stop 140 formed approximately at its midpoint along the cylindrical axis 130. The stop 140 is circular in shape and is used to prevent the tip 104 and tubular member 112 from physically touching each other. In this way, the insulator 108 thermally isolates the metallic tubular member 112 from the tip 104. Although a ceramic insulator is preferred, other insulators, such as glass or an epoxy resin, may also be used to thermally isolate the tip and tubular member as well as most other non-conducting thermal insulators.

The tubular member 112 is preferably made from stainless steel, but may be made from any other metals currently used to make food thermometers. The tubular member 112 also preferably includes an opening 144 through which the wires 126 may be threaded.

In assembling the probe 100, the tip 104 and tubular member 112 are slidably mounted over opposite ends of the insulating member 108 and brought to abut the stop 140. The diameter D1 of the insulating member 108 is slightly less than the diameter, D2, of the tip 104 and the diameter, D3, of the tubular member 112 so that in the assembled condition a tight or snug fit is provided.

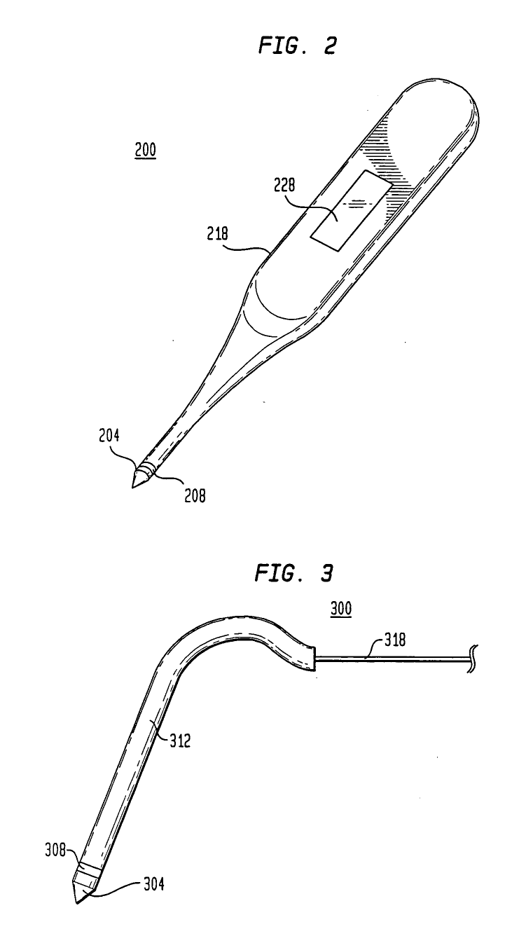

Turning now to FIG. 2, there is depicted a thermometer 200 in accordance with another aspect of the present invention. The thermometer 200 includes a tip 204 similar to the tip 104 of FIG. 1 and insulating member 208 similar to the member 108 of FIG. 1. The tip 204 and insulating member are coupled to the main body 218. In accordance with this aspect of the present invention the main body 218 is made of a flexible and bendable soft plastic and has display area 228. A microprocessor is included within the main body 218. The microprocessor is coupled to wires (such as wires 126) which run down through the main body 218 and the insulating member 208 to a thermistor (not shown) housed proximate the tip 204. In operation, the thermistor senses the temperature of the tip 204 and provides signals to the microprocessor, which then determines the temperature to be shown on display area 228. Other details associated with the operation and construction of thermometer 200 are described in U.S. Pat. No. 6,394,648, the disclosure of which is incorporated by reference herein.

Turning now to FIG. 3, there is shown a temperature probe 300 in accordance with another aspect of the present invention. In particular, the probe includes a tip 304, an insulating member 308, a curved or straight tubular portion 312 and a flexible communication line 318. The tip 304, insulating member 308 and tubular portion 312 may be constructed and connected in accordance with the tip, insulating member and insulator described herein above with respect to FIG. 1. In addition, within the enclosure of the probe 300 at the end formed by the tip 304 a thermistor is mounted and coupled to a pair of electrical wires that run up through the insulating member 308 and tubular portion 312 to the communication line 318. Thus, the temperature sensed by the thermistor within the enclosure of the probe 300 may be communicated to a device (not shown) that is coupled to the communication line 318. For example, the device may include a transmitter that communicates wireless with a remote unit as is described in U.S. Pat. No. 6,568,848, U.S. patent application Ser. Nos. 10/354,565 and 10/464,082, all of which are assigned to the assignee of the present invention, the disclosures of which are incorporated by reference herein in their entirety.

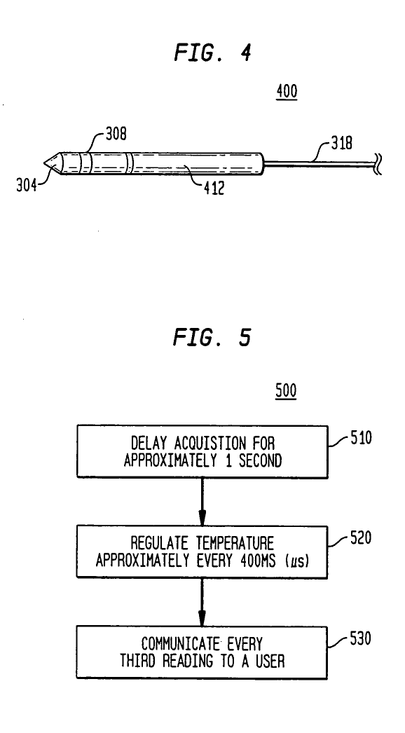

A variant on the probe shown in FIG. 3 is the probe shown in FIG. 4, which includes a substantially straight tubular portion 412.

Turning now to FIG. 5, there is depicted a method 400 in accordance with yet another aspect of the present invention. The method comprises delaying acquisition of a temperature reading (block 510) so as to allow the tip of the probe to actualize with the food whose temperature is being monitored. After approximately one second the temperature readings are taken approximately every 400 millisecond (ms) (block 520). Every three readings are compared and the third reading is communicated to a user or display device (block 530), e.g., Liquid Crystal Display (LCD). In accordance with this aspect of the present invention, a more accurate temperature probe is provided that is able to provide temperature readouts much faster, e.g., two degrees accuracy within two or three seconds, as dependent upon the temperature difference of the two mediums.

Although the present invention has been described with reference to a temperature reading being taken at a given time period, those skilled in the art will realize that the time period can be adjusted. For instance the temperature readings may be taken every 500 milliseconds. As in previous embodiments, every three readings may then be compared and the third reading is communicated to the user.

In a variant in accordance with the present invention, a combination may be provided that comprises a probe having a tip made from a conductive metal or alloy which is coupled to a microprocessor that preferably includes a program that performs a method for calibrating a temperature reading in accordance with FIG. 5.

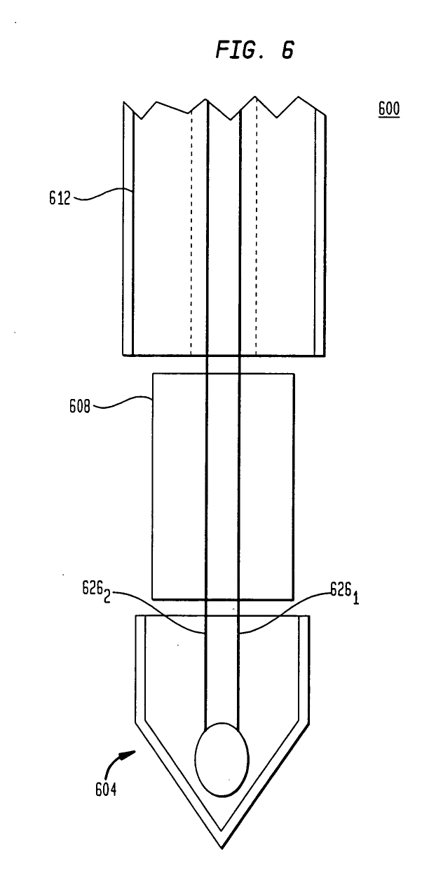

In yet another aspect of the present invention, as shown in FIG. 6, temperature probe 600 may include a thermal buffer 608 constructed from a polymer. In a preferred embodiment, the polymer is an epoxy. Thermal buffer 608 is situated between tubular member 612 and tip 604. Tip 604 preferably is constructed from copper or silver although the tip may be constructed by other highly conductive metals.

Temperature probe 600 is similarly designed to temperature probe 100. However, if the thermal buffer 608 is constructed from an epoxy material, the thermal buffer does not require hollow chambers extending therethrough. In particular, since the epoxy may be applied in a liquid or semi-liquid state, the epoxy can be disposed onto electrode wires 626₁ and 626₂. The epoxy may then be allowed to cure to form a protective shell about the wires. The protective shell may be shaped prior to or after curing.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A thermometer comprising:
an enclosure including an insulating member having first and second ends, a conductive metal tip connected to said insulating member first end and a tubular member connected to said insulating member second end; and
a thermistor mounted within said enclosure proximate said conductive metal tip and coupled to a display by a pair of wires that are coupled to said thermistor at opposing end surfaces.

2. The thermometer of claim 1, further comprising a processor coupled to said pair of wires and to said display, said processor capable of computing the temperature sensed by said thermistor based on signals communicated by said pair of wires and providing a readout to said display.

3. The thermometer of claim 2, wherein said readout is in the form of a digitally encoded signal.

4. The thermometer of claim 1, wherein said display further comprises a microprocessor which computes a temperature reading based on signals communicated by said wires and which provides a readout of the computed temperature to said display.

5. The thermometer of claim 4, wherein said readout is in the form of a digital signal.

6. The thermometer of claim 1, wherein said enclosure is substantially cylindrical in shape.

7. The thermometer of claim 1, wherein said conductive metal tip has a first end and a second end wherein the distance between said first and second ends of said metal tip is less than 2 millimeters.

8. The thermometer of claim 7, wherein the distance between the first and second ends of said conductive metal tip is at least 1.5 millimeters.

9. The thermometer of claim 1, wherein said insulating member is a ceramic insulator.

10. The thermometer of claim 1, wherein said insulating member is an epoxy.

11. The thermometer of claim 1, wherein said tubular member is made of stainless steel.

12. The thermometer of claim 1, wherein said conductive metal tip includes a silver tip.

13. The thermometer of claim 1, wherein said conductive metal tip includes a copper tip.

14. A temperature sensor comprising:
a probe having a metal tip, a stainless steel tubular portion and a thermal insulating portion;
a thermistor having opposing end surfaces mounted within said probe and coupled to a pair of electrode wires at each of said opposing end surfaces to translate thermistor signals; and
wherein said insulating portion is disposed between said metal tip and said stainless steel tubular portion so as to form a thermal buffer between said tip and tubular portion.

15. The temperature sensor of claim 14, wherein said thermistor is mounted proximate said metal tip.

16. The temperature sensor of claim 15, further wherein said stainless steel tubular portion includes an opening into which is mounted a digital display for providing a digital temperature readout.

17. The temperature sensor of claim 14, wherein said thermal insulating portion is substantially cylindrical in shape and includes an outer surface, a central cylindrical bore and a circular stop member that projects from the outer surface and wherein said tip and stainless steel tubular portion are slidably mounted over opposite ends of said thermal insulating portion so as to each abut the circular stop member.

18. The temperature sensor of claim 14, wherein said metal tip has a first end and a second end wherein the distance between said first and second ends of said metal tip is less than 2 millimeters.

19. The temperature sensor of claim 18, wherein the distance between the first and second ends of said metal tip is at least 1.5 millimeters.

20. The temperature sensor of claim 14, wherein said insulating portion is a ceramic insulator.

21. The temperature sensor of claim 14, wherein, said insulating portion is an epoxy.

22. The temperature sensor of claim 14, wherein said metal tip includes a silver tip.

23. The temperature sensor of claim 14, wherein said metal tip includes a copper tip.

24. A thermometer enclosure comprising:
a metal tip having a first end and a second end;
a cylindrically shaped thermal insulating member having a first end and a second end, said thermal insulating member first end being in communication with the first end of said silver tip; and
a metallic tubular portion having a first end and a second end, said second end of said metallic tubular portion being connected to the second end of said thermal insulating member.

25. The thermometer enclosure of claim 24, wherein the distance between said first and second ends of said metal tip is less than or equal to 2 millimeters.

26. The thermometer enclosure of claim 24, wherein the distance between the first and second ends of said metal tip is at least 1.5 millimeters.

27. The thermometer enclosure of claim 24, wherein said thermal insulating member comprises a ceramic insulator.

28. The thermometer enclosure of claim 24, wherein said thermal insulating.

29. A temperature probe comprising:
a metal tip;
a shaft member;
a ceramic buffer coupled between said metal tip and said shaft member so as to define a substantially cylindrical shape for the temperature probe; and
a thermistor mounted within said metal tip and electrically coupled to a microprocessor housed within said shaft member for calculating a temperature based on signals received from said thermistor.

30. A temperature probe comprising:
a metal tip;
a shaft member;
a thermal buffer comprising an epoxy, said buffer disposed between said metal tip and shaft member; and
a thermistor mounted between said metal tip and electronically coupled to a microprocessor housed within said shaft member for calculating a temperature based on signals received from said thermistor.

31. A computer readable medium for executing computer-readable instructions comprising:
delaying taking a reading for a second after a temperature probe is inserted in a food;
repeatedly measuring the temperature of the food every 400 milliseconds;
comparing the last three measurements to compute an average temperature; and
providing the average temperature reading to a display.

32. A computer readable medium for executing computer-readable instructions comprising:
delaying taking a reading for a first predetermined time frame after a temperature probe is inserted in a food;
repeatedly measuring the temperature of the food at a second predetermined time frame;
comparing a specified number of measurements to compute an average temperature; and
providing the average temperature reading to a display.

33. The computer readable medium for executing computer readable instructions according to claim 32, wherein said first time frame is one second.

34. The computer readable medium for executing computer readable instructions according to claim 33, wherein said second time frame is 400 milliseconds.

35. A thermometer comprising:
an enclosure including an insulating member having first and second ends, a conductive metal tip connected to said insulating member first end and a tubular member connected to said insulating member second end, said insulating member being constructed from a polymer; and
a thermistor mounted within said enclosure proximate said conductive metal tip and coupled to a display by a pair of wires that are coupled to said thermistor at opposing end surfaces.

36. The thermometer according to claim 35, wherein said polymer is an epoxy.
